(19) United States
(12) Patent Application Publication
(10) Pub. No.: US 2006/0153989 A1
(43) Pub. Date: Jul. 13, 2006

(54) Method for coating printed images

(76) Inventors: David Andrew Horsnell, Cambridge (GB); Matthew Brian Tomlin, Cambridge (GB); Christopher Michael Bates, Kettering (GB)

Correspondence Address: MCANDREWS HELD & MALLOY, LTD, 500 WEST MADISON STREET, SUITE 3400, CHICAGO, IL, 60661, US

(21) Appl. No.: 10/521,007

(22) PCT Filed: Jul. 11, 2003
(86) PCT No.: PCT/GB03/03043

§ 371 Date: Sep. 19, 2005

(30) Foreign Application Priority Data
Jul. 11, 2002 (GB) 02160182
Jul. 22, 2002 (GB) 02168854
Mar. 25, 2003 (GB) 03067899

(51) Int. Cl. B05D 1/00; B05D 3/00

(52) U.S. Cl. 427/401

(57) ABSTRACT

The present invention provides a method, and a inkjet printer configure to perform the method, of manufacturing a transfer for application to a substrate, the method comprising the steps of (a) applying an image (20, 30) to a carrier sheet (15); and (b) applying a cover coat (25, 35) over at least that area of the sheet to which the image has been applied, characterised in that the image and/or the cover coat is applied using an ink jet printer. The invention also provides a method of cover coating a transfer for application to a substrate, the method comprising the step of: coating a carrier sheet comprising one or more preprinted images by applying a cover coat over at least that area of the sheet to which an image has been applied, characterised in that the cover coat is applied using an ink jet printer.

The present invention relates to a method, notably to a method for coating printed transfers for subsequent application onto ceramic wares.

Transfers typically used for applying an image to a ceramic substrate typically comprise a carrier sheet or web having applied thereto an image and a cover coat fluid which overlies the image and usually extends radially beyond the periphery of the image. The term image is used herein to denote any form of image, for example a decorative picture or pattern, an alphanumeric batch or quality control code, a product name or code and so on. is The image may be a complete individual image or may be composed of a series of separate elements which make up a total image, as is the case for example with a pattern for the rim of a plate which may comprise a series of separate elements in a specified spatial relationship and orientation to one another. The dried cover coat film serves to retain the integrity of the image when the image is transferred from the carrier to the substrate to which it is desired to apply the image. For example, the cover coat can extend over a series of elements of an image to ensure that they are linked and retained in the desired relationship to one another as the transfer is applied to the substrate. The cover coat may then remain upon the substrate to protect the image or may be removed. For example, in applying images to ceramic articles, the image is applied to the article and the article then heated to burn off the cover coat and fire the image to the surface of the article and to burn off the cover coat. Typical temperatures for these processes are 400° C. to burn off the covercoat and 600° C. to fire the decal in place.

For convenience, the term transfer will be used herein to denote in general all types of such a structure for any use. However, the invention is of especial application in the coating of transfers for use in applying an image to a ceramic article which is then heated to remove the cover coat. The invention will be described hereinafter in terms of this preferred application.

According to a first aspect of the present invention, there is provided a method for manufacturing a transfer for application to a substrate, the method comprising the steps of (a) applying an image to a carrier sheet and (b) applying a cover coat over at least that area of the sheet to which the image has been applied, characterised in that the image and/or the cover coat is applied using an ink jet printer.

The transfer may be applied to the surface of a ceramic article which is then to be heated to fire the image to the article and remove the cover coat. Preferably, the ink jet printer is a drop on demand or impulse jet printer.

According to a second aspect of the present invention, there is provided a method for cover coating a transfer for application to a substrate, the method comprising the step of coating a pre-printed image on a carrier sheet by applying a cover coat over at least that area of the sheet to which the image has been applied, characterised in that the image and/or the cover coat is applied using an ink jet printer.

The transfer may be applied to the surface of a ceramic article which is then to be heated to fire the image to the article and remove the cover coat. Preferably, the ink jet printer is a drop on demand or impulse jet printer.

Surprisingly, we have found that such ink jet printers can be used successfully to apply the pigmented image-forming compositions and the viscous cover coat compositions to the carrier sheet of a transfer. This is despite the fact that it is known that ink jet printers are not suitable for applying highly pigmented or highly viscous materials and prima facie would not have been considered as possible mechanisms for applying the image and/or cover coat compositions.

The ability to use an ink jet printer to apply the cover coat enables the print operator to change the shape of the cover coating rapidly on line, reducing the disruption caused to the transfer production process. This enables short production runs and rapid changeovers between different transfers to be achieved economically and also reduces the lead time between the design of an image and its use in a printing process.

Since the cover coating printing is changed by altering the operation of the printer using electronic control techniques, the operator avoids the cost and complexity of changing screens and of ensuring accurate registration of the printed image and cover coat following a change of image. Furthermore, the removal of the cover coating screens from the printing process is believed to provide a number of additional benefits: the removal of the screens from the printing press reduces the cost and complexity of the printing process; and there are significant cost, space, lead time and downtime savings associated with not having to design, deliver, set up, store, maintain and repair screens.

Furthermore, many of the compositions which can be applied using an ink printer often dry rapidly. It is thus possible using the method of the invention to do away with the large and expensive drying tunnels hitherto considered essential in the manufacture of transfers, resulting in a reduced process cost. In conventional cover coating high viscosity pastes are required—typically 2 to 3 poise—these viscosities are necessary to ensure the covercoat paste can be handled in the screen print frame effectively. Using ink jet technology as described below it is possible to reduce the viscosity of the cover coating composition to obtain effective ink jet application and also use faster drying materials to achieve the required initial gelling and to reduce significantly the drying times.

We have also found that the use of such ink jet printers reduces the dribbling of “carry-over” of cover coat compositions onto the carrier sheet or between printed images which occurs with screen printing techniques. The image produced using such ink jet printers are thus often sharper than those achieved using conventional screen printing techniques. Furthermore, the controlled application provided by an ink jet printer should enable the image to be printed with less wasted fluid. the ink jet non contact process as compared with the screen print contact process should also reduce bubbling in the coated material and eliminate screen induced coating lifting.

As indicated above, the invention is of especial application in the manufacture of transfers for application to ceramic articles where the cover coat is subsequently removed from the applied image by firing or heating the article. However, the invention may be applied to the manufacture of transfers for any use where the benefits of being able to change the coating area rapidly and/or on line can be of benefit, for example in the manufacture of decal transfers for the automotive industry, for the manufacture of product identification labels in the electronics or other industries and so on. In such other applications the cover coat may remain in position overlying the image once it has been applied to the target substrate to act as a protective layer. However, in all cases the initial function of the cover coat is to retain the integrity and orientation of the elements of the image over which it has been applied. Therefore, the cover coat typically extends beyond the plan area of the image. Since the ink jet printer can apply the cover coat composition to an accurately designated area, it can apply the cover coat only to those discrete areas of the carrier sheet carrying an image or elements forming an overall image, rather than over the whole area of the sheet. Typically, the cover coat extends from 1 to 2 mms beyond the periphery of the image and may provide a bridging layer extending between individual elements of a composite image. For convenience, the invention will be described hereinafter in terms of a single image element having a single cover is coat applied so that it extends substantially uniformly approximately 1 mm beyond the edges of the image.

The carrier sheet component of the transfer structure can be made from any suitable material, for example a siliconised paper or card, from which the image can readily be separated and can take any suitable form, for example a sheet, or strip which acts as a support or carrier for the image and cover coating. Typically, the image is floated off the carrier sheet using water, or a tamp mechanism, and the carrier sheet is made from a water resistant material. Many types of suitable material are used in the transfer manufacturing industry and may be used in the present invention. For convenience, the invention will be described hereinafter in terms of the use of a sheet of a siliconised paper as the carrier sheet.

The image forming composition applied to the carrier sheet is typically a suspension of one or more suitable pigments in a fluid carrier. However, dyestuffs which are soluble dispersible or emulsify-able in the fluid carrier may also be used. Where the transfer is to be used in the ceramic industry, the pigments, dyestuffs or other colouring agents need to be stable under the conditions to which the transfer is subjected during firing of the transfer to remove the cover coat. Typically, the pigments or other image forming agents will be colouring agents.

If desired, the image-forming agent may be a mixture of materials, for example solid particulate pigments and fusible waxes or dyes. If desired, one or more of the components of the image-forming composition may undergo. interaction, for example during the heating operation, to form a different colour and/or to set or gel, as would be the case with a UV cured ink. For convenience, the invention will be described hereinafter in terms of a single image-forming ingredient which is a particulate solid suspended in a fluid carrier medium. However, it will be appreciated that different compositions may be applied through different nozzle orifices in the ink jet printer head to achieve a desired colour image or over-printing of the image-forming compositions to form a complex image.

The image-forming composition may be a water and/or organic solvent based composition and may contain any suitable proportions of pigment or other colouring agent to fluid carrier medium. However, the fluid carrier medium may be a fusible material, for example a micro-crystalline or other natural or synthetic wax, which melts upon heating to provide a fluid composition for application to the carrier sheet. However, it will usually be preferred to use a composition which is fluid at room temperature and typically the fluid carrier will be water and/or an organic solvent or diluent. Typical of such fluid carriers are lower alkanols, ketones or esters such as ethanol, propanol or butanol; lower alkyl ketones such as acetone or methylethylketone; and lower alkyl esters of monocarboxylic acids such as ethyl acetate. If desired mixtures of such solvents can be used, for example mixtures of ethanol acetone and ethylacetate, optionally in admixture with minor or major proportions of water.

The optimum fluid carrier for the image-forming composition may readily be determined by simple trial and error tests having regard to the nozzle or other orifice of the ink jet printer through which the composition is to be applied. Typically, the image-forming composition will be applied at a pressure of up to 3 Bar through a nozzle orifice of up to 500 micrometres and this will usually require that the composition have a viscosity of less than about 250 cPs at 25° C., typically less than 125 cPs. If desired the proportions of image-forming component and fluid carrier can be adjusted to achieve a viscosity within the limits required by the specific ink jet printer to be used.

For convenience, the invention will be described hereinafter in terms of the application of an image-forming composition containing to parts of a solid pigment suspended in 100 parts of methylethylketone carrier.

If desired, the image-forming composition may also contain suspension or emulsion stabilisers, viscosity modifiers and/or film-forming binders or polymers known in the ink jet printing art.

The cover coat composition is typically a film-forming composition containing a polymer in a fluid carrier. The polymer is typically an acrylate, alkyacrylate, vinyl, carbonate, styrene, or alkene polymer, copolymer, mixture, blend or alloy or a synthetic rubber, for example a butadiene/acrylate or styrene blend.

The fluid carrier is typically water or an organic solvent of the types described above for use in the image forming composition. Preferred cover coat compositions for use in the ceramics industry contain a film-forming polymer which decomposes to give volatile components upon heating and/or the polymers are thermally stable but sublime and/or volatilise when the transfer is heated. Typically such decomposition or volatilisation occurs at a temperature which is at least 20° C. below the temperature required to fire the image forming components to the glaze of the ceramic article to which the transfer has been applied. The cover coat serves to protect the image on the transfer and to retain the integrity of the image as the image is transferred from the carrier sheet to the ceramic article. The cover coat must therefore have sufficient tensile strength to achieve this function. This can be achieved by the use of polymers which have the requisite strength in thin films and/or by the application of a sufficiently thick cover coat film, for example from 20 to 50 micrometres thick, to achieve the desired tensile strength.

It will usually be desired to use the minimum of film forming polymer in the cover coat from cost considerations, for example to form a film about 30 micrometres thick. The optimum polymer and film thickness used in any given case can readily be determined by simple trial and error tests.

As with the image-forming composition, the maximum viscosity of the cover coat composition will also be determined by the type of ink printer used to apply the composition. Typically, the cover coat composition will have a viscosity of less that 250 cPs at 25° C., preferably less than 125 cPs, and will be applied at a pressure of about 3 Bar through a nozzle orifice of from 200 to 500 micrometres.

A particularly preferred cover coat composition is one comprising the film-forming polymer dissolved or suspended in 100 parts of a fluid carrier composition comprising water and/or an organic solvent such as methylethyl ketone.

The cover coat composition is typically a film-forming composition containing a polymer in a fluid carrier. The polymer is typically an acrylate, alkyacrylate, vinyl, carbonate, styrene, or alkene polymer, copolymer, mixture, blend or alloy or a synthetic rubber, for example a butadiene/acrylate or styrene blend.

The fluid carrier is typically water or an organic solvent of the types described above for use in the image forming composition. Preferred cover coat compositions for use in the ceramics industry contain a film-forming polymer which decomposes to give volatile components upon heating and/or the polymers are thermally stable but sublime and/or volatilise when the transfer is heated. Typically such decomposition or volatilisation occurs at a temperature which is at least 20° C. below the temperature required to fire the image forming components to the glaze of the ceramic article to which the transfer has been applied. The cover coat serves to protect the image on the transfer and to retain the integrity of the image as the image is transferred from the carrier sheet to the ceramic article. The cover coat must therefore have sufficient tensile strength and three-dimensional flexibility to achieve this function. This can be achieved by the use of polymers which have the requisite strength in thin films and/or by the application of a sufficiently thick cover coat film, for example from 20 to 50 micrometres thick, to achieve the desired tensile strength.

It will usually be desired to use the minimum of film forming polymer in the cover coat from cost considerations, for example to form a film typically 30 micrometres thick. The optimum polymer and film thickness used in any given case can readily be determined by simple trial and error tests. the film is also required to gel initially on the decal surface and release backing at typically 20-25° C.—this to ensure the cover coat remains accurately registered with the decal and does not flow away at the edge of the cover coat periphery.

As with the image-forming composition, the maximum viscosity of the cover coat composition will also be determined by the type of ink printer used to apply the composition. Typically, the cover coat composition will have a viscosity of less that 350 cPs at 25° C., preferably less than 200 cPs, and will be applied at a pressure of up to 3 Bar through a nozzle orifice of from 200 to 500 micrometres.

A particularly preferred cover coat composition is one comprising the film-forming polymer dissolved or suspended in 100 parts of a fluid carrier composition comprising water and/or an organic solvent such as methylethyl ketone.

In the method of the invention, the image-forming composition and/or the cover coat composition, preferably both, are applied using a drop on demand or impulse jet ink jet printer. In view of the high viscosities of the compositions, it is preferred to use a drop on demand ink jet printer which is capable of operating at pressures of up to 3 to 5 Bar using nozzle orifices of from 200 to 500 micrometres. Such printers and their operation are known in the printing field and are commercially available from Willett Limited and may be used in their commercially available forms with little or no modification. Such printers typically comprise an array of nozzle orifices in a print head past which a carrier sheet travels. Each nozzle is fed with image-forming or coating composition under the control of a valve mechanism, notably an electrical solenoid valve opened and shut by applying an electrical pulse to the appropriate valve. In this way the sequence of operation of the valves deposits image-forming or cover coating composition at the desired location on the carrier sheet moving relative to the print head. As indicated above, a series of nozzles and/or print heads can be used to deposit several different image-forming compositions to create a complex image on the carrier sheet.

The drop on demand printer can be operated in the conventional manner. However, we have found that in some circumstances due to the high viscosity of the compositions being applied, it may be desirable to apply a double electrical pulse to the solenoid valve in place of the conventional single pulse to open the valve for each printed dot. Such double pulsing of the valve can be achieved using conventional techniques. Furthermore, when applying the cover coat it may be desired to hold the valve open for prolonged periods to print continuously from a given nozzle, that is to hold the valve open for longer than three consecutive printed dots. In this case it may be desired to apply an initially high electrical pulse to open the valve and then to retain the valve in the open position by applying a holding electrical current to the valve which is only 20 to 40% of the initial current level. This reduces the risk of overheating of the valve and premature burnout of the solenoid valve.

The jetting performance of the ink jet valves and modules may be enhanced and controlled through local heating of valve, valve manifold. in this way higher viscosity fluids can be used with lower viscosity jetting—achieved by applying heat at the jetting point, also the avoidance of too high a jetting temperature can be controlled through local cooling.

As indicated above, the drop on demand printer used in the method of the invention may be a commercially available form of such a printer, except that when depositing the image forming composition it will usually be desired to use a nozzle having an orifice of from 125 to 500 micrometres so that the printer operates at pressures below about 3 Bar. However, a preferred form of drop on demand print head is one which operates at a frequency in excess of 1 kHz, preferably 2 to 4 kHz, since we have found that the use of such high frequencies enables high resolution images to be printed and that the use of such high frequencies avoids the need for the double pulsing of the valve described above. In order to achieve such high frequencies of operation, it is preferred to form the plunger of the solenoid valve as a unitary construction and from an electro-magnetically soft material having a saturation flux density greater than 1.4 Tesla, preferably about 1.6 to 1.8 Tesla, a coercivity of less than 0.25 ampere per metre, and a relative magnetic permeability in excess of 10,000. It is also preferred that the nozzle bore leading from the valve head chamber of the valve to the nozzle orifice has a length to diameter ratio of less than 8:1, preferably from 1.5:1 to 5:1, notably from 2:1 to 4:1. When a drop on demand printer it is used to deposit the cover coating composition it is advantageous use a nozzle having an orifice of from 125 to 500 micrometres so that the printer operates at pressures below about 3 Bar. However, a preferred form of drop on demand print head is one which operates at a frequency in excess of 200 Hz, preferably 600 HZ to 2 kHz.

In the method of the invention, the image-forming composition is pre-applied to the carrier sheet by either screen, litho or other printing means and the cover coating applied over that image so that the cover coat extends typically 1-3 mm beyond the edge of the image. Typically, the image will require some time to dry to a sufficient extent for the cover coat to be applied over it without causing puckering, bleeding of the image into the cover coat and other problems. It is usual, therefore, to incorporate a drying step between the image application and cover coat application steps. Such drying steps include IR heating or hot air heating, or may occur spontaneously where the image-forming composition is cured through IR radiation or by chemical interactions. In some cases it may be possible to carry out both the image printing and cover coat application on a single print station, for example where the image-forming composition is cured by UV radiation and the drying time between printing and overcoating is virtually eliminated.

Where the image printing and the cover coat application are carried out at separate stations, it will usually be necessary to provide some means by which the operation of the cover coat printer can be synchronised with that of the image printer. Such synchronisation can be achieved using timing marks upon the carrier sheet and photocells to detect the passage of those marks. Alternatively, the movement of the carrier sheet can be monitored by means of a shaft encoder on one or more of the drive shafts of the carrier sheet transport mechanism and inter-linking the output from the shaft encoder(s) to the operation of the printers. Such inter-linking and synchronisation of the operation of the carrier transport and the printers can be achieved electronically.

As indicated above, the operation of the printers and the patterns which they print are controlled electronically so that they can readily be varied without the interruption and complexity of replacing screens or plates as with conventional printing techniques. The operations can be readily adjusted on line so that minor errors in registration or positioning of images and/or cover coats can be rectified on line by simple input from a keyboard or other control means. This electronic control also allows the form of the image to be varied rapidly and on line so that different transfers can be made with minimal interruption of the printing and coating operations.

The invention will now be illustrated by the following examples in which all parts and percentages are given by weight unless stated otherwise.

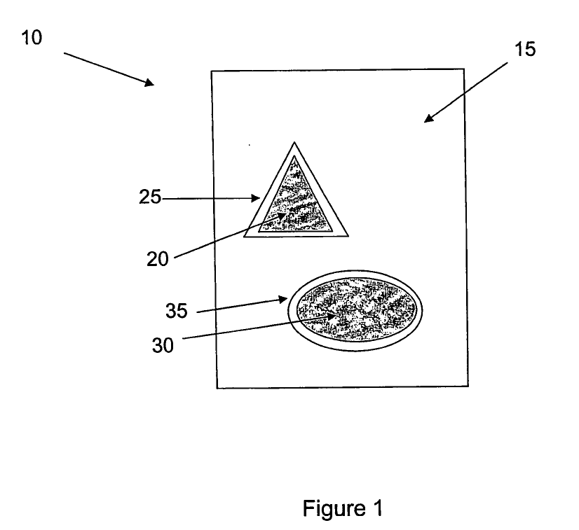

FIG. 1 shows a schematic depiction of a transfer sheet 10 comprising a sheet of siliconised paper 15 upon which are printed images 20, 30 and associated cover coatings 25, 35 which extend over the associated image and for approximately 1 mm beyond the edge of the image. The image-forming composition consists of a suspension of particles of the film-forming polymer in a solution of Orasol black dye in methylethylketone. The cover coating composition consists of a dispersion of a blend of butyl rubber (95 parts) and polymethylmethacrylate (5 parts) in methylethylketone and has a viscosity of 100 cp at 25° C.

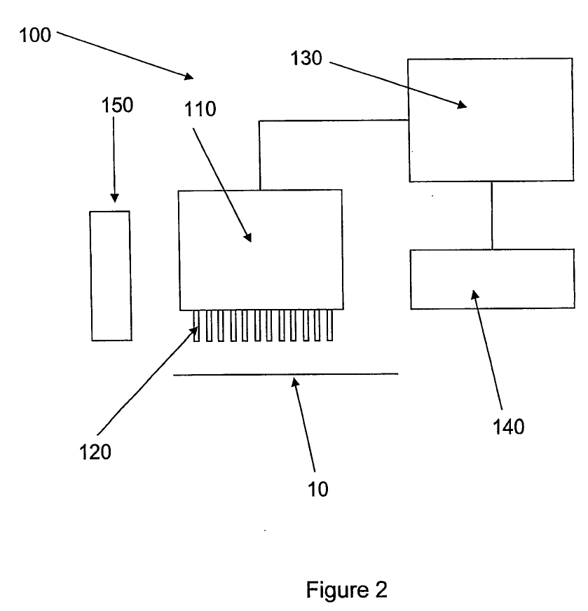

FIG. 2 shows a schematic depiction of a printing apparatus used for depositing the cover coat 25, 35 over the associated images 20, 30. The printing apparatus 100 comprises an inkjet printer 110 and a control system 130. The inkjet printer comprises an array of nozzles 120 that are arranged to deposit cover coating material on a transfer sheet 10. As the transfer sheet is moved relative to the apparatus (either by moving the array of nozzles 120 or the transfer sheet 10) the control system causes one or more of the nozzles to be opened such that the cover coating is applied to the appropriate regions of the transfer sheet. The printing apparatus may additionally comprise a dryer 150 to assist the drying of the applied cover coat material.

The deposition of the cover coat material is determined by the control system 130. In order to deposit the cover coat material over the associated image the control system must determine the location of these images: this may be achieved by passing data used by a similar printing system to deposit the images on the transfer sheet to the control system. This data is then used to calculate the areas over which cover coat material is to be applied, and this data is then used to control the nozzle array. Alternatively, a scanner 140 may be connected to the control system 130 such that the images 20, 30 on the transfer sheet can be identified and located, and the areas to be covered with cover coat material can be determined by the control system.

It will be understood that the apparatus used to apply the cover coating material may be integrated with the apparatus used to apply the image(s). The image data is transferred to the control system and the image applied to the transfer sheet, and the image dried (either by waiting for an appropriate period of time or by using the dryer. The cover coating material is then applied over the images and subsequently dried. Different nozzle arrays would be required to deposit the materials used to form the image and the cover coating.

The image-forming composition was applied to the carrier sheet using a Willett 700 drop on demand ink jet printer operating at a pressure of 2 Bar and having an array of nozzles with a nozzle orifice diameter of 250 micrometres to print a solid black square approximately 2 cm square. The printed image was allowed to dry naturally as the carrier sheet travelled for about 10 seconds to the cover coat printer station where a film about 30 micrometres thick of the cover coating composition was applied by a Willett 700 drop on demand printer operated at 3 Bar and using a nozzle orifice size of 250 micrometres. The cover coat extended substantially uniformly 1 mm beyond the edge of the image and dried to a solid film within 10 seconds. If desired a hot air drier may be used to assist drying and curing of the cover coat. During the above operation, the shape and size of the image and it associated cover coat were changed to a 3 cm equilateral triangular shape by altering the sequence of actuation of the solenoid valves in the print heads. During the transition from the square to triangular shape about six transfers were lost through mis-shaping of the printed images and cover coats. In a further embodiment of the present invention, the cover coating fluid composition was applied to a pre-printed carrier sheet using a Willett 700 drop on demand ink jet printer operating at a pressure of 0.75-1 Bar and having an array of nozzles with a nozzle orifice diameter of 500 microns to print a solid overcoat strip approximately 6 mm wide and 30 microns thick. The cover coat extended substantially uniformly 1 mm beyond the edge of the image and dried to a solid film within 10 seconds.

With the above arrangement, a scanner can be provided to scan a desired pattern and the information from the scanner then manipulated using conventional image processing technology to provide the data input to create a new set of printer control instructions for the image printer and the cover coating printer.

The ink jet valves may be assembled into an array by means of a manifold and the modules so created would either be traversed across a decal sheet or provided as a fixed array. This enables the ink jet valve components to be changed in a rapid manner. Furthermore, such an embodiment may also incorporate a fast plug-in replacement process for the valves and/or manifolded valve modules.

International patent application PCT/CA02/01544 describes an ink jet printer that may be used to perform a method according to the present invention.

Although the present invention is concerned with the application of a cover coating to ceramic ware, it will be understood that such a technique may be integrated with a digital colour printing process for ceramic ware. As the printed image is stored in a data file., the data file can be accessed by the cover coating application system in order to process the data held in the file in order to create the cover coat pattern that is to be applied to the ceramic ware. In an alternative arrangement, a scanner can be provided to scan a desired pattern and the information from the scanner can then be manipulated using conventional image processing technology to provide the data input used to create a new cover coat pattern.

1. A method of manufacturing a transfer for application to a substrate, the method comprising the steps of
(a) applying an image to a carrier sheet; and
(b) applying a cover coat over at least that area of the sheet to which the image has been applied, characterised in that the image and/or the cover coat is applied using an ink jet printer.

2. A method according to claim 1, wherein the ink jet printer is a drop on demand printer.

3. A method according to claim 1 or claim 2, wherein the image is applied using a first ink jet printer having a nozzle orifice of between 125 and 500 μm and being operated at a frequency of greater than 1 kHz.

4. A method according to claim 3, wherein the first drop on demand ink jet printer is operated at a frequency of between 2 and 4 kHz.

5. A method according to any of claims 3 to 4, wherein the first drop on demand ink jet printer is operated at a pressure of approximately 3 Bar.

6. A method according to any of claims 3 to 5, wherein the material deposited to form the image has a viscosity of less than 250 cp.

7. A method according to claim 6, wherein the material deposited to form the image has a viscosity of less than 125 cp.

8. A method according to claim 1 or claim 2, wherein the cover coat is applied using a second ink jet printer having a nozzle orifice of between 125 and 500 μm and being operated at a frequency of greater than 200 Hz.

9. A method according to claim 8, wherein the second drop on demand ink jet printer is operated at a frequency of between 600 and 2000 Hz.

10. A method according to any of claims 8 or 9, wherein the second drop on demand ink jet printer is operated at a pressure of approximately 3 Bar.

11. A method according to any of claims 8 to 10, wherein the material deposited to form the image has a viscosity of less than 300 cp.

12. A method according to claim 11, wherein the material deposited to form the image has a viscosity of less than 200 cp.

13. A method of cover coating a transfer for application to a substrate, the method comprising the step of:
coating a carrier sheet comprising one or more pre-printed images by applying a cover coat over at least that area of the sheet to which an image has been applied, characterised in that the cover coat is applied using an ink jet printer.

14. A method according to claim 13, wherein the ink jet printer is a drop on demand printer.

15. A method according to claim 14, wherein the drop on demand ink jet printer is operated at a frequency of between 600 and 2000 Hz.

16. A method according to any of claims 14 or 15, wherein the drop on demand ink jet printer is operated at a pressure of approximately 3 Bar.

17. A method according to any of claims 14 to 16, wherein the material deposited to form the image has a viscosity of less than 300 cp.

18. A method according to claim 17, wherein the material deposited to form the image has a viscosity of less than 200 cp.

19. An ink jet printer configured to perform the method of any preceding claim.
